(19) United States
(12) Patent Application Publication
(10) Pub. No.: US 2023/0212408 A1
(43) Pub. Date: Jul. 6, 2023

(54) ANTICORROSIVE NON-SKID COATING COMPOSITION

(71) Applicant: TESLA NANOCOATINGS, INC., Massillon, OH (US)

(72) Inventors: Jorma VIRTANEN, Massillon, OH (US); Theodore HAMMER, Akron, OH (US); Todd HAWKINS, Massillon, OH (US)

(21) Appl. No.: 17/567,994

(22) Filed: Jan. 4, 2022

(51) Int. Cl. C09D 5/10; C09D 5/24; C09D 7/40; C09D 7/61; C09D 163/00

(52) U.S. Cl. CPC C09D 5/106; C09D 5/24; C09D 7/70; C09D 7/67; C09D 7/68; C09D 7/69; C09D 7/61; C09D 163/00

(57) ABSTRACT

An anticorrosive non-skid coating composition is disclosed herein, including at least one curable resin, at least one curing agent, sacrificial metal particles, and at least one carbonaceous material.

### I. FIELD

The present teaching relates to anticorrosive non-skid coating compositions offering cathodic protection, the methods of making, and the methods of using same.

### II. BACKGROUND

Non-skid coating systems are frequently applied to stairs, floors, walkways, and deck areas to provide slip resistance to personnel and equipment. Successful non-skid coatings must exhibit high coefficients of friction coupled with excellent abrasion resistance and impact resistance. Depending on the end-use, these coatings systems may also be engineered to provide good resistance to moisture, chemicals, or UV-exposure.

Non-skid coating compositions are usually prepared by mixing a liquid coating with aggregates that provide slip resistance. The formulation is subsequently applied to a substrate to provide a textured surface with a high level of traction. Alternatively, the aforementioned aggregates can be thrown across the top of a wet coating, a process that is known as broadcasting. The latter technique results in a more controlled non-skid profile but at the cost of a lengthier application process.

Thermoset or thermoplastic binders can be used in non-skid coating compositions. Epoxy binders are regularly employed because of the excellent adhesion and durability that is provided by these systems. Other binders such as polyurethanes, polyureas, polyaspartics, vinyl esters, and elastomeric acrylics, for example, can also be used. Another element of non-skid coatings is the appropriate selection and loading level of fillers.

Non-skid coatings are generally applied to a substrate via roller. Light pressure is applied to the coating as it is pulled across the substrate, which to creates ridges and troughs. A trowel or squeegee can also be used to apply these types of coatings. More recently, non-skid coatings have been applied with spray equipment such as the Graco M680 and hopper guns. This approach is advantageous because it dramatically improves productivity, albeit at the expense of losing the ridged profile that is created by the roller.

Cathodic protection is essential for the protection of metals such as carbon steel, stainless steel, steel alloys, aluminum, and aluminum alloys. This method of protection is particularly important for metals that are used in extremely corrosive environments e.g., on ships and offshore oil and gas structures. These assets are regularly exposed to rain, seawater, salts, intense UV-light, and harsh temperatures. All of these conditions accelerate the corrosion process, which results in costly maintenance and, if left unaddressed, can lead to structural failure.

Cathodic protection has traditionally been achieved with coating systems that contain a high loading level of sacrificial metal particles. Historically, zinc has been the preferred sacrificial metal for these types of applications. The best anticorrosion coatings usually contain≥80% by weight of zinc in the dry film. Sometimes, the loading level of zinc in the dry film can reach or exceed 90%, by weight. At these loading levels, zinc exceeds the percolation threshold (which is approximately 30% by volume for spherical particles) thereby resulting in a zinc network that is electrically connected to the metal substrate. As a consequence of this high pigment volume concentration (PVC), zinc-rich primers generally exhibit poor mechanical properties, are damaged easily, and are prone to adhesive failure and mud-cracking.

Zinc-rich primers are commonly used in conjunction with non-skid coatings in highly corrosive environments. The non-skid coating typically serves as the mid-coat or topcoat and provides the coating system with abrasion resistance, impact resistance, weatherability, and slip resistance. If the non-skid coating is serving as the topcoat, mid-coats might also be used if there is poor adhesion between the zinc-rich primer and the non-skid coating. Furthermore, a topcoat, such as an exterior-durable polyurethane, may be applied over non-skid coatings to provide better UV-stability.

U.S. Pat. No. 4,760,103 describes non-skid coating formulations that are comprised of epoxy resins, polyamides, pigments, fillers, solvent, aggregates, and polypropylene fibers. Compared to earlier inventions, the inclusion of aggregates into this system drastically improved the durability and longevity of the coating.

U.S. Pat. No. 5,686,507 describes non-skid coating formulations that are comprised of epoxy resins, amine hardeners, pigments, fillers, solvents, aggregates, and Kevlar flakes or fibers. When applied with a phenolic core roller, the coating exhibited outstanding non-skid properties. The inclusion of Kevlar into the coating improved the impact resistance as well as the non-skid profile. Additionally, because these coating compositions were free of crystalline silica, a common ingredient in many non-skid coating compositions, the hazards associated with this coating were significantly lower.

However, none of the aforementioned systems contain sacrificial metal particles that can provide cathodic protection. Consequently, the aforementioned examples must be applied over a zinc-rich primer in order for the coating system to provide high levels of corrosion resistance. Unfortunately, this multi-coat approach is undesirable because it increases the cost of the coating system and it extends the duration of the coating application process. This can, for example, keep an oil platform out of commission for two or more days. Furthermore, during this downtime, the potential for surface contamination increases because the non-skid coating cannot be applied over the primer (or any other intermediate coats that might be present) until it is sufficiently dry. If the surface becomes contaminated by dust, salts, water, oil, and/or chemicals, film defects can occur, which inevitably lead to coating failure. As such, a one-coat solution is desirable.

As previously mentioned, zinc-rich coatings require very high loading levels of zinc. To achieve cathodic protection, zinc loading levels are typically ≥80% by weight of the dry film. For a coating to exhibit useful mechanical properties, the total binder content should be approximately 20% by weight of the dry film. To achieve a textured surface with good non-skid characteristics, 15 to 40% by weight of the dry film should consist of aggregates. Without accounting for pigments, fillers, and additives, one would yield a composition that is 115% by weight when incorporating the minimum amount of each component. This is not possible.

As such, certain aspects of the formulation, such as the zinc content, must be reduced. One approach that can be used to reduce the loading level of zinc, while maintaining cathodic protection, is to incorporate electrically conductive carbonaceous material. U.S. Pat. No. 9,953,739 describes corrosion-resistant coating compositions that contain sacrificial metal particles and a carbonaceous material that can form electrical contact between the sacrificial metal particles. The carbonaceous material may consist of graphene, graphite, fullerene, carbon nanotubes (CNTs), or amorphous carbon such as conductive carbon black. These carbonaceous materials may be used alone or in combination with one another.

Another approach that can be used to reduce the zinc loading level is to incorporate conductive materials having quasi two-dimensional structures such as zinc flake particles. Zinc flake has a lamellar structure with a higher surface area than spherically-shaped zinc dust. Furthermore, the lamellar structure of zinc flakes can improve the barrier properties of the film thereby reducing the amount of moisture and soluble salts that can migrate through the film. U.S. Pat. Nos. 5,338,348, 5,334,631, and 7,201,790 describe zinc-rich coatings that incorporate zinc flake particles.

All of the aforementioned compositions of U.S. Pat. Nos. 9,953,739; 5,338,348; 5,334,631; and 7,201,790 provided good corrosion resistance. However, there was no mention of the mechanical properties of these compositions. It is also evident that none of these compositions will provide non-skid properties, because there is no mention of large aggregates that would increase the coefficient of friction.

The present teaching solves all these problems. Through a combination of zinc particles and carbonaceous material, the percolation threshold of zinc can be reduced. This affords one the ability to achieve an electrically connected network at lower zinc loading levels while simultaneously enhancing the mechanical properties of the composition. This reduction in zinc content allows other raw materials to be included, such as aggregates, which can provide non-skid properties. Accordingly, anticorrosive non-skid coatings capable of providing cathodic protection, high levels of traction, and excellent mechanical properties are presented.

### III. SUMMARY

An advantage with the present teaching is the ability of these compositions to provide a textured finish with good non-skid characteristics, excellent mechanical properties, and cathodic protection. This can be achieved without the application of an anticorrosive primer or a non-skid topcoat. As such, a one-coat solution is presented here.

Another advantage with the present teaching is the inclusion of carbonaceous material, such as, but not limited to, carbon nanotubes (CNTs), graphene, graphite, fullerene, or amorphous carbon which can improve the mechanical properties of the coating.

Yet another advantage with the present teaching is the electrical conductivity of the carbonaceous material. The inclusion of carbonaceous material into the composition lowers the percolation threshold of the coating and, consequently, the loading level of zinc that is necessary for achieving cathodic protection.

Yet another advantage with the present teaching is the inclusion of zinc flakes which, with its quasi 2-dimensional structure, reduces further the zinc loading level that is necessary for achieving cathodic protection.

Still another advantage with the present teaching is that it can be applied with a roller, with a trowel, with a squeegee, or with spray equipment such as the Graco ToughTek M680 mortar pump sprayer or a hopper gun. All application techniques provide coatings with high coefficients of friction. Application of the coating via roller provides the highest level of traction due to the undulated profile that is created; spray application dramatically improves productivity which can, in many cases, be more expensive than the product itself.

Still other benefits and advantages will become apparent to those skilled in the art to which it pertains upon a reading and understanding of the following detailed specification.

### IV. DEFINITIONS

Carbon nanotubes (CNTs)—A three-dimensional carbonaceous material, comprised solely of carbon atoms, that are covalent bound to one another by sp² bonds.

Cathode—The negatively charged electrode.

Anode—The positively charged electrode.

Cathodic protection—A method of corrosion control whereby a metal substrate is made the cathode of an electrochemical cell.

Carbonaceous material—Encompasses the different allotropes of carbon such as, but not limited to, single- and multi-walled carbon nanotubes, fullerene, graphene, graphite, and amorphous carbon.

Sacrificial metal—A metallic species that acts as the anode in a cathodic protection system which, consequently, corrodes preferentially relative to the cathodic metal that it is protecting.

Binder—Any natural or synthetic matrix that binds a coating composition together. Binders can be thermoset or thermoplastic materials.

Resin modifiers—Specialty resins, reactive diluents, and/or non-reactive diluents and plasticizers. Examples of resin modifiers may include, but are not limited to, Epon 58006, Epodil 748, and Epodil LV5.

Substrate—An underlying surface in which a coating is applied over the top of.

Primer—A coating that is in contact with the substrate.

Topcoat—A coating that is applied over a primer or over a mid-coat that is in contact with the atmosphere.

Mid-coat (or Tie-coat)—A coating that is applied between the primer and topcoat. Mid-coats are typically used to improve inter-coat adhesion.

Non-skid coating—A coating that offers a high coefficient of friction that is commonly applied to stairs, floors, walkways, deck areas, roadways, and platforms to provide traction to users and equipment. The term, “non-skid coating” is often used interchangeably with similar terms such as, “non-slip coating,” “anti-slip coating,” or “anti-skid coating.”

Zinc dust—A spherical form of zinc particles.

Zinc flake—A lamellar form of zinc particles.

### V. BRIEF DESCRIPTION OF FIGURES

The present teachings are described hereinafter with reference to the accompanying drawings.

FIG. 1 shows a schematic depiction of the present teaching;

FIG. 2 shows a photograph of a cured composition when applied via roller; and,

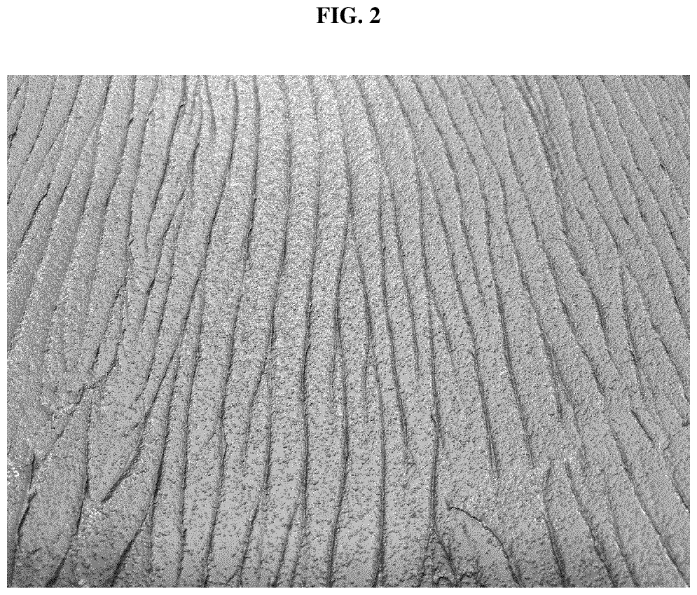

FIG. 3 shows a photograph of a cured composition when applied via spray application.

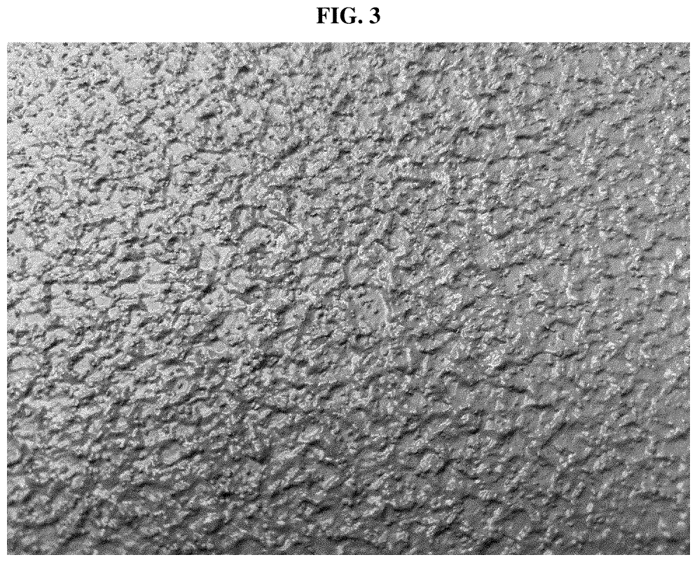

### VI. DETAILED DESCRIPTION

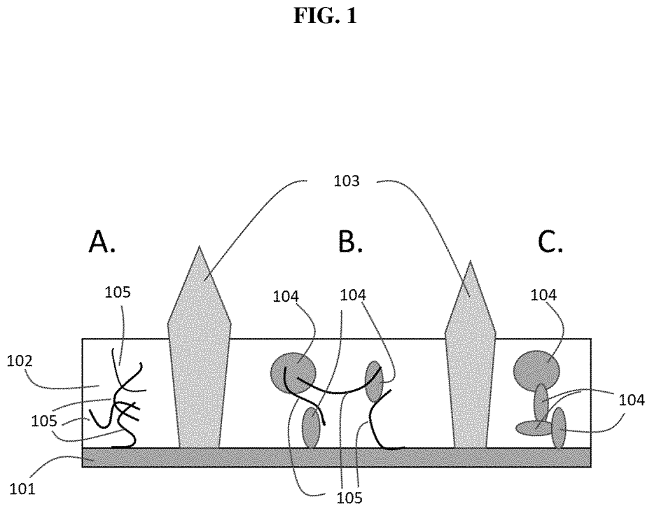

As illustrated in FIG. 1, anticorrosive properties can be obtained by adding sacrificial metal particles (104) into a coating matrix (102). The sacrificial metal particles can be electrically connected with the substrate (101) it is protecting. Accordingly, three possible electrical conduction pathways can be created and are described as follows: A) between CNTs (105) only; B) between the zinc particles (104) and the CNTs (105); or C) between the zinc particles (104) only. According to measurements shown in Examples 1-3, the mixed case B, provides the best conductivity and is the least sensitive to disturbances due to large, non-conductive aggregates (103) that provide non-skid properties.

The present teaching relates to non-skid coating compositions capable of providing cathodic protection. Because the present teaching does not require an anticorrosive primer, such as a zinc-rich primer, or a weatherable topcoat, a one-coat solution is presented here. Typical formulations that are in accordance with the present teaching are comprised of curable resins, modifiers, curing agents, sacrificial metal particles, carbonaceous material, aggregates, fillers, pigments, and solvents. Specific examples are provided in Table 4 below, but it should be apparent to one skilled in the art that a range of each component can be used to afford a system with useful properties. As such, any composition containing, by weight, of approximately 5 to approximately 20% curable resins, approximately 0 to approximately 7.5% modifiers, approximately 25 to approximately 65% sacrificial metal particles, approximately 10 to approximately 40% aggregates, approximately 0.001 to approximately 5.0% carbonaceous material, approximately 0 to approximately 20% solvent, approximately 0 to approximately 10% pigments, approximately 3 to approximately 18% fillers, and approximately 3 to approximately 15% of curing agents would encompass the general scope of the present teaching.

Suitable binders that are in accordance with the present teaching may be selected from epoxies, polyurethanes, polyureas, polyaspartics, vinyl esters, and elastomeric acrylics.

The conventional resins that are in accordance with the present teaching may be selected from the group of epoxy-functional resins, amine-functional resins, hydroxyl-functional resins, and vinyl ester-functional resins. Suitable epoxy-functional resins may include, but are not limited to, liquid (e.g., Epon 828), solid (e.g., Epon 1001), and solution epoxies (Epon 872-X-75); Suitable vinyl ester-functional resins may include, but are not limited to, bisphenol A diglycidyl ether compounds having acrylate (ECOCRYL Resin 03582) or methacrylate (e.g., ECOCRYL Resin 03789) groups; Suitable hydroxyl-functional resins may include, but are not limited to, polyol resins such as polyesters, polyethers, polycarbonates, polybutadienes, polycaprolactones, acrylics, natural oils, and polysulfides; Suitable amine-functional resins may include, but are not limited to, aliphatic amines, cycloaliphatic amines, aromatic amines, aspartic esters, polyamides, polyether amines, polyethyleneimines, blocked amines, hindered amines, amine adducts, and modified amines.

Specialty resins may be used to improve specific properties of the coating such as the adhesion, tensile strength, flexibility, thermal shock resistance, or impact resistance. These specialty resins may be used alone but can also be used in combination with conventional resins. Suitable examples that are in accordance with the present teaching include, but are not limited to, elastomer-modified epoxies such as Epon 58006 or internally flexibilized epoxies such as Cardolite's NC-514.

Resin modifiers that are in accordance with the present teaching are materials that can modify the properties of conventional resins. These resin modifiers are never used alone and are always used in combination with a conventional resin. An example of a conventional resin is Epon 828 (the diglycidyl ether of bisphenol A). Modifiers can include, but are not limited to, reactive diluents and reactive plasticizers such as cresyl glycidyl ether, butyl glycidyl ether, C12-C14 aliphatic glycidyl ethers, butanediol diglycidyl ether, and cyclohexanedimethanol diglycidyl ether; non-reactive diluents and plasticizers such as high boiling point hydrocarbon molecules, benzyl alcohol, nonyl phenol, styrenated phenol, and cardanol; polyepoxides and polyols with flexible structures such as Heloxy 505 and polycin D-265, respectively; and toughening agents such as Croda B-Tough C2x. Hydroxyl- and phenolic-functional plasticizers such as benzyl alcohol and nonyl phenol have the added benefit of catalyzing epoxy-amine reactions.

The curing agents that are in accordance with the present teaching may be selected from the group of curing agents that contain amine functional groups, thiol functional groups, or isocyanate functional groups. Suitable amine functional group-containing curing agents in accordance with the present teaching may include, but are not limited to, modified and unmodified aliphatic amines, modified and unmodified cycloaliphatic amines, amidoamines, polyamides, phenalkamines, phenalkamides, polyetheramines, polyethyleneimines, Mannich bases, imidazolines, adducts, partially-blocked amines, hindered amines, and mixtures thereof. Suitable thiol functional-group containing curing agents in accordance with the present teaching may include, but are not limited to, mercaptan monomers and polymers. Suitable isocyanate functional group-containing curing agents in accordance with the present teaching may include, but are not limited to, aliphatic polyisocyanates (e.g., Desmodur N3200 and Desmodur N3300), aromatic polyisocyanates (e.g., Desmodur L75 and Desmodur VL), and cycloaliphatic polyisocyanates (e.g., Desmodur XP 2406).

Sacrificial metal particles that are in accordance with the present teaching include zinc, magnesium, nickel, aluminum, cobalt, and mixtures thereof. Alloys of zinc, magnesium, nickel, aluminum, cobalt, and mixtures thereof may also be used. The geometry of the sacrificial metal particles may be spherical or lamellar and can be used alone, or in combination with one another. The ratio of spherical to lamellar metal particles may be anywhere from about 20:1 to about 1:20. In one aspect of the present teaching, the spherical particles are used in excess relative to the lamellar particles. In another aspect of the present teaching, the ratio of spherical to lamellar metal particles will be anywhere between about 8:1 and about 2:1. The sacrificial metal particles should have an average diameter ranging between about 0.01 to about 100 microns.

Inorganic and organic corrosion inhibitors can be added to the composition to supplement the corrosion resistance of the coating. Suitable corrosion inhibitors that are in accordance with the present teaching are anodic inhibitors, cathodic inhibitors, mixed inhibitors, and volatile corrosion inhibitors. These inhibitors may be used alone or in combination with one another. Suitable examples may include, but are not limited to, N-nitrosamines, mercaptobenzothiazoles, zinc phosphates, calcium phosphates, zinc aluminum orthophosphates, strontium aluminum polyphosphates, and zinc molybdenum orthophosphates.

The compositions of the present teaching are principally designed for metal substrates although they can be used on any substrate where protection of said substrate and non-skid properties are desired. The metal substrates of interest can consist of different types of steel such as, but not limited to, carbon steel, stainless steel, and steel alloys as well as aluminum and aluminum alloys.

Carbonaceous material increases the electrical conductivity and the mechanical properties of the composition. Carbonaceous material that is in accordance with the present teaching includes carbon nanotubes, graphene, graphite, fullerene, amorphous carbon black, and mixtures thereof.

Organic solvents or water can be used to adjust the viscosity, pot-life, and workability of the composition. Suitable solvents may be selected from xylenes, aromatic hydrocarbon mixtures such as solvent 100, alcohols such as butanol, glycol ethers such as propylene glycol monomethyl ether, glycol ether esters such as propylene glycol monomethyl ether acetate, aliphatic hydrocarbons such as n-hexane, esters such as tert-butyl acetate, ketones such as methyl ethyl ketone, and water. These solvents may be used alone or in combination with one another to achieve good film formation. In one aspect of the present teaching, a mixture of xylenes, aromatic hydrocarbons, butanol, and tert-butyl acetate is used.

Additives can optionally be added to the composition to impart certain characteristics. Suitable additives in accordance with the present teaching may include wetting agents, pigment dispersants, defoamers, rheology modifiers/thixotropes, adhesion promoters, surface modifiers (e.g., waxes), catalysts, UV-light absorbers, and light stabilizers.

Filler materials can be used to adjust the rheological and mechanical properties of the non-skid coating system. Filler materials can also have the added benefit of improving the corrosion resistance of the composition. Suitable fillers in accordance with the present teaching include mica, kaolin, calcium carbonate, talc, corundum, micaceous iron oxide, barium sulfate, nepheline syenite, ceramic microspheres, glass microspheres, diatomaceous earth, wollastonite, clay, feldspar, quartz, glassflake, garnet, silica, and mixtures thereof.

Aggregates impart abrasion resistance and non-skid properties to the composition. Suitable aggregates in accordance with the present teaching may be derived from native elements, silicates, oxides, sulfides, sulfates, halides, carbonates, phosphates, and mineraloids. In one aspect of the present teachings, the aggregates have a Mohs hardness≥5, and in another aspect, a Mohs hardness that is ≥7. In another aspect of the present teaching, the aggregates include sand, aluminum oxide, aluminum granules, polymer beads, ceramic beads, silicon carbide, garnet, metal particles, crushed walnut shells, rubber crumbs, flint, quartz, stones, glass, silica, or mixtures thereof. In one aspect of the present teaching, the aggregate can have an average particle size ranging from 0.063 to 1.70 mm, from 0.125 to 1.40 mm, or from 0.250 to 1.180 mm.

Silane coupling agents such as, but not limited to, 3-aminopropyltriethoxysilane, 3-isocyanatopropyltriethoxysilane, and 3-methacryloxypropyltrimethoxysilane can be added to the composition to bind the organic polymer matrix to the inorganic fillers and aggregates. These coupling agents are useful for improving the cohesive strength of the composition.

One method of preparing curable compositions includes mixing component A, which contains the curable resin, with component B, which contains the curing agent. The aggregate may be incorporated into component A or into component B. Alternatively, the aggregate can be added separately as a third component, component C. In one aspect of the present teaching, component C is added to the mixture of component A and component B. This mixture of all three components is then applied to a substrate to create the non-skid coating. In another aspect of the present teaching, the mixture of component A and component B is applied to a substrate.

Component C is then added over the top of the mixture of component A and component B to create the non-skid coating.

### EXAMPLES

Preliminary electrical resistance measurements were conducted to find alternative means of lowering the electrical resistance of conventional zinc-rich coatings. It was found that higher loading levels of zinc dust led to lower electrical resistance. However, the addition of CNTs, zinc flakes, and/or graphene dramatically decreased the resistance values at a constant zinc dust loading level (see Tables 1-3). Therefore, zinc flakes and carbonaceous material were beneficial to obtaining the desired percolation threshold in a complicated system filled with non-conductive components.

### Example 1

Electrical resistance measurements of a zinc-rich coating with a 1.0:1.0 resin:curing agent equivalency. Teslan 1102 having a perfect stoichiometric balance between the resin and curing agent and different loading levels of CNTs, was applied to glass panels, and cured for 1 week at ambient temperature followed by 24 hours at 60° C. Electrical resistance measurements were made and are summarized in Table 1.

TABLE 1
Resistance measurements of Teslan 1102 having perfect stoichiometric
and different loading levels of CNTs where 100% CNT is the existing
concentration in the commercially-available product.

| | Composition | | |
|---|---|---|---|
| | Teslan 1102 with | Teslan 1102 with | Teslan 1102 with |
| | 150% CNT | 100% CNT | 80% CNT |
| Resistance | 0.79 Ω | 3.7 Ω | 250 kΩ-1 Ω |

### Example 2

Electrical resistance measurements of a zinc-rich coating with a 1.1:1.0 resin:curing agent equivalency. Teslan 1102 having an excess of resin and different loading levels of CNTs, was applied to glass panels and cured for 1 week at ambient temperature followed by 24 hours at 60° C. Electrical measurements were made and are summarized in Table 2.

TABLE 2
Resistance measurements of Teslan 1102 having excess resin and
different loading levels of CNTs where 100% CNT is the existing
concentration in the commercially-available product.

| | Composition | | |
|---|---|---|---|
| | Teslan 1102 with | Teslan 1102 with | Teslan 1102 with |
| | excess epoxy, | excess epoxy, | excess epoxy, |
| | 150% CNT | 100% CNT | 80% CNT |
| Resistance | 0.05 Ω | 0.17 Ω | 0.87 kΩ-1 Ω |

### Example 3

Electrical resistance measurements of a zinc-rich coating with a 0.9:1.0 resin:curing agent equivalency. Teslan 1102 having an excess of curing agent and different loading levels of CNTs, was applied to glass panels and cured for 1 week at ambient temperature followed by 24 hours at 60° C. Electrical measurements were made and are summarized in Table 3.

TABLE 3
Resistance measurements of Teslan 1102 having excess curing agent
and different loading levels of CNTs where 100% CNT is the existing
concentration in the commercially-available product.

| | Composition | | |
|---|---|---|---|
| | Teslan 1102 with | Teslan 1102 with | Teslan 1102 with |
| | excess epoxy, | excess epoxy, | excess epoxy, |
| | 150% CNT | 100% CNT | 80% CNT |
| Resistance | 5.9 Ω | n.d. | 0.18 Ω |

Where n.d. is not determined.

### Example 4

Preparation of the non-skid coating compositions.

Typical formulations that are in accordance with the present teaching are provided in Table 4 below. The amount of each raw material is displayed as a weight percentage.

Component A was prepared by adding the resin, modifier, thixotropes, and carbonaceous material dispersion into a kettle that was equipped with an air-driven mixer. The mixing shaft was fitted with a Cowels blade and the mixture was homogenized. The titanium dioxide, zinc particles, and filler were subsequently added. The dry ingredients were added slowly to ensure that adequate mixing was achieved. Solvent from the let-down was added as needed to maintain adequate mixing. The mixture was heated to 65° C. with high shear mixing and was continued until a homogeneous consistency was obtained. Thereafter, the remaining let-down solvent was added and the batch was cooled.

Component B was prepared by adding the curing agent, solvents, and catalyst to a kettle equipped with an air-driven mixer. The mixing shaft was fitted with a propeller blade and the contents were mixed at low speed until completely homogeneous.

Similar procedures were used to prepare component A and component B for each of the subsequent formulations. Although specific amounts of each raw material are mentioned in the examples provided, it should be apparent to a person skilled in the art that a compositional range can be used to achieve non-skid coatings with useful properties.

The non-skid coating is made by stirring components A, B, and C together until homogeneous. Once the components are mixed together, the coating can be applied to a substrate with a roller, trowel, squeegee, or by spray application. The aggregates, which are denoted as component C, may be added as a separate, third component, as is presented in Table 4 below. However, the aggregates may also be incorporated into component A or component B ahead of time, during the preparation of component A and component B. As such, the non-skid coating may exist as either a 2-component or 3-component system.

Alternatively, the non-skid coating can be made by stirring components A and B until homogenous and then applying said mixture to a substrate. This can be accomplished with a roller, trowel, squeegee, or by spray application. The aggregates can then be applied over the top of the wet coating, via a process known as broadcasting, to create the non-skid coating.

TABLE 4

| Raw | Composition | | | | | | | | | |
|---|---|---|---|---|---|---|---|---|---|---|
| materials | 1 | 2 | 3 | 4 | 5 | 6 | 7 | 8 | 9 | 10 |
| Part A | | | | | | | | | | |
| Conventional | 15.18 | 7.95 | 13.54 | 9.98 | 9.89 | 12.09 | 8.87 | 12.61 | 12.57 | 8.95 |
| resins | | | | | | | | | | |
| Resin | 1.22 | 0.80 | 0.47 | 0.00 | 0.62 | 0.40 | 0.55 | 0.42 | 1.67 | 2.10 |
| modifiers | | | | | | | | | | |
| Thixotropes | 1.22 | 1.05 | 0.89 | 0.95 | 0.94 | 0.80 | 0.84 | 0.80 | 0.99 | 0.85 |
| Carbonaceous | 4.07 | 2.93 | 2.65 | 2.81 | 2.78 | 2.32 | 2.49 | 3.15 | 3.04 | 2.52 |
| material | | | | | | | | | | |
| dispersion | | | | | | | | | | |
| TiO₂ | 4.07 | 3.56 | 2.65 | 2.81 | 2.78 | 2.32 | 2.49 | 3.15 | 2.74 | 2.52 |
| pigment | | | | | | | | | | |
| Zinc | 37.59 | 54.25 | 44.41 | 42.91 | 44.42 | 38.02 | 37.19 | 43.07 | 41.96 | 45.23 |
| particles | | | | | | | | | | |
| Solvents | 5.84 | 5.16 | 5.12 | 5.24 | 4.94 | 5.18 | 4.82 | 4.20 | 3.50 | 4.70 |
| Filler | 3.38 | 3.34 | 5.30 | 7.36 | 7.42 | 4.84 | 6.54 | 5.57 | 5.33 | 7.05 |
| Part B | | | | | | | | | | |
| Curing | 8.90 | 5.36 | 6.62 | 5.74 | 5.75 | 6.01 | 5.81 | 6.28 | 6.35 | 5.74 |
| agents | | | | | | | | | | |
| Solvents | 0.88 | 0.60 | 0.74 | 0.64 | 0.64 | 0.67 | 0.65 | 0.70 | 0.71 | 0.64 |
| Catalysts | 0.61 | 0.42 | 0.37 | 0.32 | 0.32 | 0.34 | 0.32 | 0.35 | 0.35 | 0.32 |
| Part C | | | | | | | | | | |
| Aggregates | 17.06 | 14.57 | 21.37 | 19.39 | 19.48 | 27.01 | 29.43 | 19.70 | 20.78 | 19.32 |
| Total | 100 | 100 | 100 | 100 | 100 | 100 | 100 | 100 | 100 | 100 |

The cured compositions of Table 4 exhibited excellent non-skid properties, as denoted by their high coefficients of friction (>0.80 in both wet and dry conditions). Films were hard and impact resistant and displayed excellent corrosion resistance, as determined via impact resistance testing (ASTM D2794) and neutral salt spray exposure (ASTM B117), respectively. Systems that were exposed to neutral salt spray testing showed no evidence of blistering, cracking, disbonding, or face rusting; rust creepage ratings, in accordance with ASTM D1654, were no less than 7 but generally between 8-9 on a scale of 0-10 where a rating of 0 is more than 16 mm of rust creepage and a rating of 10 is 0 mm of rust creepage. A 2 mm wide scribe was used for all neutral salt spray tests.

Clause 1—An anticorrosive non-skid coating composition including at least one curable resin, at least one curing agent, sacrificial metal particles, and at least one carbonaceous material.

Clause 2—The composition of clause 1, wherein the composition further includes at least one filler, aggregates, and at least one solvent.

Clause 3—The composition of clauses 1 or 2, wherein the at least one curable resin is chosen from the group consisting of an epoxy-functional resin, a hydroxyl-functional resin, an amine-functional resin, and a vinyl ester-functional resin.

Clause 4—The composition of clauses 1-3, wherein the at least one curing agent contains amine functional groups, thiol functional groups, or isocyanate functional groups.

Clause 5—The composition of clauses 1-4, wherein the at least one curing agent is chosen from the group consisting of modified and unmodified aliphatic amines, modified and unmodified cycloaliphatic amines, amidoamines, polyamides, adducts, imidazolines, phenalkamines, phenalkamides, Mannich bases, polyetheramines, polyethyleneimines, mercaptan monomers, mercaptan polymers, aliphatic polyisocyanates, cycloaliphatic polyisocyanates, aromatic polyisocyanates, and mixtures thereof.

Clause 6—The composition of clauses 1-5, wherein the sacrificial metal particles are chosen from the group consisting of zinc, aluminum, magnesium, nickel, cobalt, mixtures thereof, alloys of zinc, aluminum, magnesium, nickel, cobalt, and mixtures thereof.

Clause 7—The composition of clauses 1-6, wherein the sacrificial metal particles have an average diameter ranging between about 0.01 to about 100 microns and have a geometry that is spherical, lamellar, or a combination thereof.

Clause 8—The composition of clauses 1-7, wherein the at least one carbonaceous material is chosen from the group consisting of carbon nanotubes, graphene, graphite, fullerene, amorphous carbon, and mixtures thereof.

Clause 9—The composition of clauses 1-8, wherein the at least one carbonaceous material is electrically conductive and thereby capable of lowering the electrical resistance of the coating.

Clause 10—The composition of clauses 2-9, wherein the aggregates have a Mohs hardness that is ≥5 and have an average particle size ranging from about 0.063 mm to about 1.70 mm, wherein the aggregates are chosen from the group consisting of native elements, silicates, oxides, sulfides, sulfates, halides, carbonates, phosphates, mineraloids, sand, aluminum oxide, aluminum granules, polymer beads, ceramic beads, silicon carbide, garnet, metal particles, rubber crumbs, flint, quartz, stones, glass, silica, or mixtures thereof.

Clause 11—The composition of clauses 2-10, wherein the fillers are chosen from the group consisting of mica, kaolin, calcium carbonate, corundum, talc, barium sulfate, micaceous iron oxide, diatomaceous earth, wollastonite, clay, feldspar, quartz, nepheline syenite, glassflake, garnet, ceramic microspheres, glass microspheres, silica, and mixtures thereof.

Clause 12—The composition of clauses 1-11, wherein the composition further includes at least one corrosion inhibitor, wherein the corrosion inhibitors are chosen from the group consisting of inorganic, organic, anodic, cathodic, mixed, volatile, and mixtures thereof.

Clause 13—The composition of clauses 1-12, wherein the composition further includes at least one additive, wherein the additive is chosen from the group consisting of wetting agents, pigment dispersants, defoamers, rheology modifiers/thixotropes, adhesion promoters, surface modifiers, catalysts, UV-light absorbers, light stabilizers, and mixtures thereof.

Clause 14—The composition of clauses 1-13, wherein the composition further includes at least one silane coupling agent.

Clause 15—The composition of clauses 1-14, wherein the composition does not contain an anti-corrosive primer.

Clause 16—A method for preparing a non-skid surface, the method including the steps of providing a first component by mixing at least one curable resin, sacrificial metal particles, and at least one carbonaceous material, mixing the first component with at least one curing agent, and applying the mixture of the first component and the least one curing agent to a substrate.

Clause 17—The method of clause 16, wherein the first component further comprises at least one filler and at least one solvent, wherein aggregates are additionally mixed with the first component and the at least one curing agent.

Clause 18—The method of clauses 16 or 17, wherein the mixture of the first component, the at least one curing agent, and the aggregates are applied by a roller, by trowel application, by squeegee, or by spray application.

Clause 19—The method of clauses 16-18, wherein the non-skid surface provides cathodic protection, non-skid properties, while only requiring one coat.

Clause 20—The method of clauses 16-19, wherein the non-skid surface has a coefficient of friction of >0.50.

The various aspects of the present teaching have been described, hereinabove. It will be apparent to those skilled in the art that the above composition and method may incorporate changes and modifications without departing from the general scope. It is intended to include all such modifications and alterations in so far as they come within the scope of the appended claims or the equivalents thereof.

Having thus described the composition and method, it is now claimed:

1. An anticorrosive non-skid coating composition comprising:
at least one curable resin;
at least one resin modifier, wherein the resin modifier is chosen from the group consisting of reactive diluents, plasticizers, and flexibilized epoxies;
at least one curing agent;
sacrificial metal particles, wherein the sacrificial metal particles have a geometry that is a combination of spherical and lamellar;
aggregates, wherein the aggregates are capable of raising a coefficient of friction of a cured composition to at least 0.50; and
at least one carbonaceous material.

2. The composition of claim 1, wherein the composition further comprises:
at least one filler;
and
at least one solvent.

3. The composition of claim 1, wherein the at least one curable resin is chosen from the group consisting of an epoxy-functional resin, a hydroxyl-functional resin, an amine-functional resin, and a vinyl ester-functional resin.

4. The composition of claim 1, wherein the at least one curing agent contains amine functional groups, thiol functional groups, or isocyanate functional groups.

5. The composition of claim 4, wherein the at least one curing agent is chosen from the group consisting of modified and unmodified aliphatic amines, modified and unmodified cycloaliphatic amines, amidoamines, polyamides, adducts, imidazolines, phenalkamines, phenalkamides, Mannich bases, polyetheramines, polyethyleneimines, mercaptan monomers, mercaptan polymers, aliphatic polyisocyanates, cycloaliphatic polyisocyanates, aromatic polyisocyanates, and mixtures thereof.

6. The composition of claim 1, wherein the sacrificial metal particles are chosen from the group consisting of zinc, aluminum, magnesium, nickel, cobalt, mixtures thereof, alloys of zinc, aluminum, magnesium, nickel, cobalt, and mixtures thereof.

7. The composition of claim 6, wherein the sacrificial metal particles have an average diameter ranging between about 0.01 to about 100 microns, wherein the ratio of spherical to lamellar particles is between about 20:1 to about 1:20.

8. The composition of claim 1, wherein the at least one carbonaceous material is chosen from the group consisting of carbon nanotubes, graphene, graphite, fullerene, amorphous carbon, and mixtures thereof.

9. The composition of claim 8, wherein the at least one carbonaceous material is electrically conductive and thereby capable of lowering the electrical resistance of a coating.

10. The composition of claim 2, wherein the aggregates have a Mohs hardness that is ≥5 and have an average particle size ranging from about 0.063 mm to about 1.70 mm, wherein the aggregates are chosen from the group consisting of native elements, silicates, oxides, sulfides, sulfates, halides, carbonates, phosphates, mineraloids, sand, aluminum oxide, aluminum granules, polymer beads, ceramic beads, silicon carbide, garnet, metal particles, rubber crumbs, flint, quartz, stones, glass, silica, or mixtures thereof.

11. The composition of claim 2, wherein the fillers are chosen from the group consisting of mica, kaolin, calcium carbonate, corundum, talc, barium sulfate, micaceous iron oxide, diatomaceous earth, wollastonite, clay, feldspar, quartz, nepheline syenite, glassflake, garnet, ceramic microspheres, glass microspheres, silica, and mixtures thereof.

12. The composition of claim 2, wherein the composition further comprises:
at least one corrosion inhibitor, wherein the corrosion inhibitors are chosen from the group consisting of inorganic, organic, anodic, cathodic, mixed, volatile, and mixtures thereof.

13. The composition of claim 2, wherein the composition further comprises:
at least one additive, wherein the additive is chosen from the group consisting of wetting agents, pigment dispersants, defoamers, rheology modifiers/thixotropes, adhesion promoters, surface modifiers, catalysts, UV-light absorbers, light stabilizers, and mixtures thereof.

14. The composition of claim 2, wherein the composition further comprises at least one silane coupling agent.

15. The composition of claim 1, wherein the composition does not contain an anti-corrosive primer.

16-20. (canceled)

21. The composition of claim 1, wherein the sacrificial metal particles are approximately 25% to approximately 65% by weight.

22. The composition of claim 21, wherein the sacrificial metal particles are a combination of zinc dust and zinc flakes.

23. The composition of claim 22, wherein the at least one carbonaceous material is carbon nanotubes.

24. The composition of claim 23, wherein the composition further comprises:
at least one filler;
at least one solvent;
at least one corrosion inhibitor;
at least one additive, wherein the additive is chosen from the group consisting of wetting agents, pigment dispersants, defoamers, rheology modifiers/thixotropes, adhesion promoters, surface modifiers, catalysts, UV-light absorbers, light stabilizers, and mixtures thereof; and
at least one silane coupling agent.
